(19) United States
(12) Patent Application Publication
(10) Pub. No.: US 2024/0291027 A1
(43) Pub. Date: Aug. 29, 2024

(54) SOLID ELECTROLYTE MATERIAL AND BATTERY USING SAME

(71) Applicant: Panasonic Intellectual Property Management Co., Ltd., Osaka (JP)

(72) Inventors: TOMOYUKI KOMORI, Osaka (JP); KENSUKE WAKASUGI, Tokyo (JP); TAKEHIRO TANAKA, Hyogo (JP); AKIHIKO SAGARA, Nara (JP)

(21) Appl. No.: 18/527,289

(22) Filed: Dec. 3, 2023

Related U.S. Application Data
(63) Continuation of application No. PCT/JP2022/019228, filed on Apr. 28, 2022.

(30) Foreign Application Priority Data
Jun. 9, 2021 (JP) 2021-096904

(51) Int. Cl. H01M 10/0562; C01F 17/36; H01M 10/0525

(52) U.S. Cl. CPC H01M 10/0562; C01F 17/36; H01M 10/0525; C01P 2002/30; C01P 2002/72; C01P 2006/40; H01M 2300/008

(57) ABSTRACT

The solid electrolyte material of the present disclosure comprises Li, M, Y, Gd, and I. M is at least one selected from the group consisting of Mg, Sr, Ba, and Zn. The battery of the present disclosure comprises a positive electrode, a negative electrode, and an electrolyte layer provided between the positive electrode and the negative electrode. At least one selected from the group consisting of the positive electrode, the negative electrode, and the electrolyte layer comprises the solid electrolyte material of the present disclosure.

### BACKGROUND

### 1. Technical Field

The present disclosure relates to a solid electrolyte material and a battery using it.

### 2. Description of the Related Art

Japanese Unexamined Patent Application Publication No. 2011-129312 discloses an all-solid-state battery using a sulfide solid electrolyte.

International Publication No. WO 2018/025582 discloses a solid electrolyte material represented by a formula of Li_{6-3z}Y_{z}X₆ (0<z<2, X=Cl or Br).

### SUMMARY

One non-limiting and exemplary embodiment provides a new solid electrolyte material that is suitable for conduction of lithium ions.

In one general aspect, the techniques disclosed here feature a solid electrolyte material comprising Li, M, Y, Gd, and I, wherein M is at least one selected from the group consisting of Mg, Sr, Ba, and Zn.

The present disclosure provides a new solid electrolyte material that is suitable for conduction of lithium ions.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 shows a cross-sectional view of a battery 1000 according to a second embodiment;

FIG. 2 shows a schematic view of a compression molding dies 300 that is used for evaluating the ion conductivity of a solid electrolyte material;

FIG. 3 is a graph showing a cole-cole plot obtained by impedance measurement of a solid electrolyte material of Example 1;

FIG. 4 is a graph showing X-ray diffraction patterns of solid electrolyte materials of Examples 1 to 23; and

FIG. 5 is a graph showing the initial discharge characteristics of a battery of Example 1.

### DETAILED DESCRIPTIONS

Embodiments of the present disclosure will now be described with reference to the drawings.

### First Embodiment

The solid electrolyte material according to a first embodiment comprises Li, M, Y, Gd, and I, wherein M is at least one selected from the group consisting of Mg, Sr, Ba, and Zn.

The solid electrolyte material according to the first embodiment is a solid electrolyte material suitable for ion conduction. The solid electrolyte material according to the first embodiment can have, for example, a practical lithium ion conductivity such as a high lithium ion conductivity.

Here, the high lithium ion conductivity is, for example, greater than or equal to 1.00×10⁻⁵ S/cm at around room temperature. The solid electrolyte material according to the first embodiment can have, for example, an ion conductivity of greater than or equal to 1.00×10⁻⁵ S/cm.

The solid electrolyte material according to the first embodiment can be used for obtaining a battery having excellent charge and discharge characteristics. An example of the battery is an all-solid-state battery. The all-solid-state battery may be a primary battery or may be a secondary battery.

It is desirable that the solid electrolyte material according to the first embodiment does not substantially include sulfur. The fact that the solid electrolyte material according to the first embodiment does not substantially include sulfur means that the solid electrolyte material does not include sulfur as a constituent element, except for sulfur that is unavoidably mixed as an impurity. In this case, the amount of sulfur mixed in the solid electrolyte material as an impurity is, for example, less than or equal to 1 mol %. From the viewpoint of safety, the solid electrolyte material according to the first embodiment desirably does not contain sulfur. A sulfur-free solid electrolyte material does not generate hydrogen sulfide even if exposed to the atmosphere and is therefore excellent in safety. The sulfide solid electrolyte disclosed in Japanese Unexamined Patent Application Publication No. 2011-129312 may generate hydrogen sulfide when exposed to the atmosphere.

The solid electrolyte material according to the first embodiment may contain an element that is unavoidably mixed. Examples of the element are hydrogen, oxygen, and nitrogen. These elements may be present in the raw material powders of the solid electrolyte material or in the atmosphere for manufacturing or storing the solid electrolyte material.

The solid electrolyte material according to the first embodiment may consist essentially of Li, M, Y, Gd, and I. Here, the fact that “the solid electrolyte material according to the first embodiment consists essentially of Li, M, Y, Gd, and I” means that the proportion (i.e., molar fraction) of the total amount of Li, M, Y, Gd, and I to the total amount of all elements constituting the solid electrolyte material according to the first embodiment is greater than or equal to 95%.

In order to enhance the ion conductivity of the solid electrolyte material, the solid electrolyte material according to the first embodiment may consist of Li, M, Y, Gd, and I only.

In order to enhance the ion conductivity of the solid electrolyte material, the solid electrolyte material according to the first embodiment may further comprise X. Here, X is at least one selected from the group consisting of Cl and Br.

In order to enhance the ion conductivity of the solid electrolyte material, the solid electrolyte material according to the first embodiment may consist essentially of Li, M, Y, Gd, I, and X. The solid electrolyte material according to the first embodiment may consist of Li, M, Y, Gd, I, and X only.

In order to enhance the ion conductivity of the solid electrolyte material, M may comprise at least one selected from the group consisting of Mg and Zn. M may be one selected from the group consisting of Mg and Zn.

The solid electrolyte material according to the first embodiment may be represented by the following formula (1):

Li_{3-2a-3b}M′ₐ(Y_{1-y}Gd_{y})_{1+b}(Cl_{1-p-q}BrₚI_{q})₆ (1)
here, M′ is at least one selected from the group consisting of Mg and Zn, and the following mathematical expressions:

0<y<1;

0≤p<1;

0<q≤1;

0<(p+q)≤1;

0<a;

0≤b; and

0<(a+b)<1,

are satisfied.

The material represented by the formula (1) has a high ion conductivity.

The upper and lower limits of the value range of “y” in the formula (1) may be regulated by an arbitrary combination selected from the numerical values of greater than 0, 0.1, 0.2, 0.8, 0.9, and less than 1.

In order to enhance the ion conductivity of the solid electrolyte material, in the formula (1), a mathematical expression: 0.1≤y≤0.9 may be satisfied, a mathematical expression: 0.1≤y≤0.2 may be satisfied, or y=0.2 may be satisfied.

The upper and lower limits of the value range of “p” in the formula (1) may be regulated by an arbitrary combination selected from the numerical values of 0, 0.2, 0.3, 0.4, 0.9, and less than 1.

In order to enhance the ion conductivity of the solid electrolyte material, in the formula (1), a mathematical expression: 0<p<1 may be satisfied, 0.2≤p≤0.9 may be satisfied, or p=0.4 may be satisfied.

The upper and lower limits of the value range of “q” in the formula (1) may be regulated by an arbitrary combination selected from the numerical values of greater than 0, 0.1, 0.4, 0.7, 0.8, and 1.

In order to enhance the ion conductivity of the solid electrolyte material, in the formula (1), a mathematical expression: 0<q<1 may be satisfied, or 0<q<0.8 may be satisfied.

In order to enhance the ion conductivity of the solid electrolyte material, in the formula (1), a mathematical expression: 0.1≤q≤0.7 may be satisfied, or q=0.4 may be satisfied.

The upper and lower limits of the value range of “a” in the formula (1) may be regulated by an arbitrary combination selected from the numerical values of greater than 0, 0.05, 0.2, 0.3, 0.4, and 0.5.

In order to enhance the ion conductivity of the solid electrolyte material, in the formula (1), a mathematical expression: 0.05≤a≤0.4 may be satisfied, or a=0.05 may be satisfied.

The upper and lower limits of the value range of “b” in the formula (1) may be regulated by an arbitrary combination selected from the numerical values of 0, 0.05, 0.1, 0.15, 0.2, 0.25, 0.3, and 0.4.

In order to enhance the ion conductivity of the solid electrolyte material, in the formula (1), a mathematical expression: 0≤b≤0.25 may be satisfied, or b=0.25 may be satisfied.

In order to enhance the ion conductivity of the solid electrolyte material, in the formula (1), a mathematical expression: 0<(a+b)≤0.5 may be satisfied, or 0<(a+b)<0.5 may be satisfied.

The X-ray diffraction pattern of the solid electrolyte material according to the first embodiment can be obtained by X-ray diffraction measurement by a θ-2θ method using Cu-Kα rays (wavelength: 1.5405 angstrom and 1.5444 angstrom, i.e., wavelength: 0.15405 nm and 0.15444 nm). In the obtained X-ray diffraction pattern, at least one peak may be present within a diffraction angle 2θ range of greater than or equal to 12.0° and less than or equal to 16.0°, and at least one peak may be present within a diffraction angle 2θ range of greater than or equal to 24.0° and less than or equal to 29.0°. A crystal phase having these peaks is called a first crystal phase. A solid electrolyte material containing a first crystal phase easily forms paths for diffusion of lithium ions in the crystal and therefore has a high ion conductivity.

In the first crystal phase, at least one peak may be further present within a diffraction angle 2θ range of greater than 32.0° and less than or equal to 35.0°.

The first crystal phase belongs to a monoclinic system. That is, the solid electrolyte material according to the first embodiment may comprise a crystal phase belonging to a monoclinic system. The term “monoclinic system” in the present disclosure means a crystal phase having a similar crystal structure to Li₃ErBr₆ disclosed in the ICSD (inorganic crystal structure database) Collection Code 50182 and has an X-ray diffraction pattern particular to this structure. In the present disclosure, the fact of “having a similar crystal structure” means being classified in the same space group and having a similar atomic arrangement structure, and does not limit the lattice constant.

In an X-ray diffraction pattern of the solid electrolyte material according to the first embodiment obtained by X-ray diffraction measurement using Cu-Kα rays, at least one peak may be present within a diffraction angle 2θ range of greater than or equal to 29.0° and less than or equal to 32.0°. A crystal phase having these peaks is called a second crystal phase. A solid electrolyte material containing a second crystal phase easily forms paths for diffusion of lithium ions in the crystal and therefore has a high ion conductivity.

The second crystal phase belongs to a trigonal system. That is, the solid electrolyte material according to the first embodiment may comprise a crystal phase belonging to a trigonal system. The term “trigonal system” in the present disclosure means a crystal phase having a similar crystal structure to Li₃ErCl₆ disclosed in the ICSD (inorganic crystal structure database) Collection Code 50151 and having an X-ray diffraction pattern particular to this structure.

The solid electrolyte material according to the first embodiment may further comprise a third crystal phase that is different from the first and second crystal phases. That is, the solid electrolyte material according to the first embodiment may further comprise a third crystal phase having a peak outside the diffraction angle 2θ ranges above. The third crystal phase may lie between the first crystal phase and the second crystal phase. The third crystal phase may belong to, for example, an orthorhombic system. The “orthorhombic system” in the present disclosure means a crystal phase having a similar crystal structure to Li₃YbCl₆ disclosed in the ICSD (inorganic crystal structure database) Collection Code 50152 and having an X-ray diffraction pattern particular to this structure.

The solid electrolyte material according to the first embodiment may be a mixture of crystalline and amorphous materials. Here, the term “crystalline” refers to that a sharp peak (i.e., peak) is present in the X-ray diffraction pattern. The term “amorphous” refers to that a broad peak (i.e., halo) is present in the X-ray diffraction pattern. In a mixture of crystalline and amorphous materials, a peak and a halo are present in the X-ray diffraction pattern.

In an X-ray diffraction pattern of the solid electrolyte material according to the first embodiment obtained by X-ray diffraction measurement using Cu-Kα rays, the full width at half maximum of a peak having the highest intensity within a range of greater than or equal to 25.0° and less than or equal to 30.0° may be less than or equal to 0.30°. Consequently, the solid electrolyte material according to the first embodiment includes a crystalline region and therefore has an improved ion conductivity.

The full width at half maximum is a width represented by the difference between two diffraction angles at which the intensity is a half value I_{hMAX} of the maximum intensity I_{MAX} of the peak. The I_{hMAX} is determined by (I_{MAX}−I_{bg})/2+I_{bg}. Here, I_{bg} is the intensity at the baseline. The intensity I_{bg} of the baseline is the average of the intensities at diffraction angles 2θ from 250° to 26.0°.

The shape of the solid electrolyte material according to the first embodiment is not limited. Examples of the shape are needle, spherical, and oval spherical shapes. The solid electrolyte material according to the first embodiment may be a particle. The solid electrolyte material according to the first embodiment may have a pallet or planar shape.

When the shape of the solid electrolyte material according to the first embodiment is, for example, particulate (e.g., spherical), the solid electrolyte material may have a median diameter of greater than or equal to 0.1 μm and less than or equal to 100 μm or may have a median diameter of greater than or equal to 0.5 μm and less than or equal to 10 μm. Consequently, the solid electrolyte material according to the first embodiment and other materials can be well dispersed. The median diameter of a particle means the particle diameter (d50) at which the accumulated volume is 50% in a volume-based particle size distribution. The volume-based particle size distribution is measured with, for example, a laser diffraction measurement apparatus or an image analyzer.

### Method for Manufacturing Solid Electrolyte Material

The solid electrolyte material according to the first embodiment is manufactured by, for example, the following method.

Raw material powders of one or more halides are mixed so as to give a target composition.

As an example, the target composition is presumed as Li_{2.9}Mg_{0.05}Y_{0.8}Gd_{0.2}Cl_{1.2}Br_{2.4}I_{2.4}. In this case, raw material powders of LiBr, LiI, MgBr₂, YCl₃, YBr₃, and GdCl₃ are mixed at a molar ratio of LiBr:LiI:MgBr₂:YCl₃:YBr₃:GdCl₃ of about 1.3:6.1:0.2:0.6:1.6:0.6. The raw material powders may be mixed at a molar ratio adjusted in advance so as to offset a composition change that may occur in the synthesis process.

Raw material powders in a mixture form are heat-treated and reacted with each other in an inert gas atmosphere to obtain a reaction product. Examples of the inert gas are helium, nitrogen, and argon. The heat treatment may be performed in vacuum. In the heat-treatment process, a mixture of raw material powders is placed in a container (e.g., crucible and vacuum sealed tube) and may be heat-treated in a heating furnace.

Alternatively, a reaction product may be obtained by mechanochemically reacting raw material powders with each other in a mixing apparatus such as a planetary ball mill. That is, raw material powders may be mixed and reacted using a mechanochemical milling method. The thus-obtained reaction product may be further heat-treated in an inert gas atmosphere or in vacuum.

The solid electrolyte material according to the first embodiment is obtained by these methods.

The composition of a solid electrolyte material can be determined by, for example, inductively coupled plasma emission spectrometry or ion chromatography. For example, the compositions of Li, M, Y, and Gd can be determined by inductively coupled plasma emission spectrometry, and the composition of I can be determined by ion chromatography.

### Second Embodiment

A second embodiment will now be described. Matters described in the first embodiment may be omitted.

In the second embodiment, a battery using the solid electrolyte material according to the first embodiment will be described.

The battery according to the second embodiment comprises a positive electrode, a negative electrode, and an electrolyte layer. The electrolyte layer is provided between the positive electrode and the negative electrode. At least one selected from the group consisting of the positive electrode, the electrolyte layer, and the negative electrode comprises the solid electrolyte material according to the first embodiment.

The battery according to the second embodiment comprises the solid electrolyte material according to the first embodiment and thereby has excellent charge and discharge characteristics. The battery may be an all-solid-state battery.

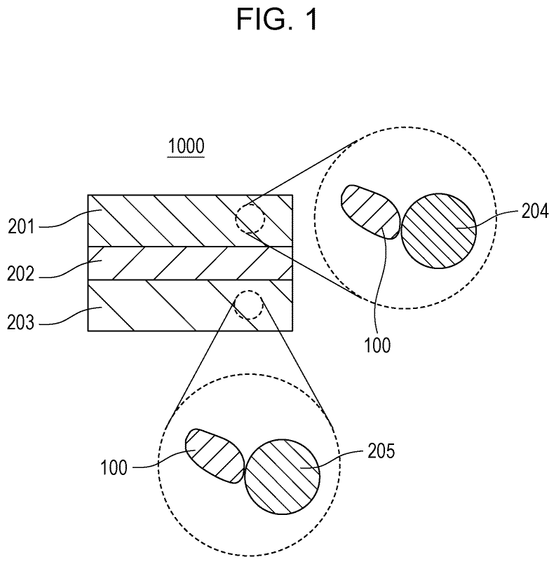

FIG. 1 shows a cross-sectional view of a battery 1000 according to the second embodiment.

The battery 1000 according to the second embodiment comprises a positive electrode 201, an electrolyte layer 202, and a negative electrode 203. The electrolyte layer 202 is provided between the positive electrode 201 and the negative electrode 203.

The positive electrode 201 contains a positive electrode active material particle 204 and a solid electrolyte particle 100.

The electrolyte layer 202 contains an electrolyte material.

The negative electrode 203 contains a negative electrode active material particle 205 and a solid electrolyte particle 100.

The solid electrolyte particle 100 is a particle consisting of the solid electrolyte material according to the first embodiment or a particle including the solid electrolyte material according to the first embodiment as a main component. Here, “a particle including the solid electrolyte material according to the first embodiment as a main component” means a particle in which the component included in the largest molar ratio is the solid electrolyte material according to the first embodiment.

The solid electrolyte particle 100 may have a median diameter of greater than or equal to 0.1 μm and less than or equal to 100 μm. When the median diameter is greater than or equal to 0.5 μm and less than or equal to 10 μm, the solid electrolyte particle 100 has a higher ion conductivity.

The positive electrode 201 contains a material that can occlude and release metal ions (e.g., lithium ions). The material is, for example, a positive electrode active material (e.g., the positive electrode active material particle 204).

Examples of the positive electrode active material are a lithium-containing transition metal oxide, a transition metal fluoride, a polyanionic material, a fluorinated polyanionic material, a transition metal sulfide, a transition metal oxyfluoride, a transition metal oxysulfide, and a transition metal oxynitride. Examples of the lithium-containing transition metal oxide are Li(Ni,Co,Al)O₂ and LiCoO₂. When the lithium-containing transition metal oxide is used as the positive electrode active material, the manufacturing cost can be reduced, and the average discharge voltage can be increased.

In the present disclosure, “(A,B,C)” means “at least one selected from the group consisting of A, B, and C”.

The positive electrode active material particle 204 may have a median diameter of greater than or equal to 0.1 μm and less than or equal to 100 μm. When the positive electrode active material particle 204 has a median diameter of greater than or equal to 0.1 μm, the positive electrode active material particle 204 and the solid electrolyte particle 100 can form a good dispersion state in the positive electrode 201. Consequently, the charge and discharge characteristics of the battery are improved. When the positive electrode active material particle 204 has a median diameter of less than or equal to 100 μm, the lithium diffusion speed in the positive electrode active material particle 204 is improved. Consequently, the battery can operate at a high output.

The positive electrode active material particle 204 may have a median diameter greater than that of the solid electrolyte particle 100. Consequently, the positive electrode active material particle 204 and the solid electrolyte particle 100 can form a good dispersion state in the positive electrode 201.

In order to increase the energy density and output of the battery, in the positive electrode 201, the ratio of the volume of the positive electrode active material particle 204 to the sum of the volume of the positive electrode active material particle 204 and the volume of the solid electrolyte particle 100 may be greater than or equal to 0.30 and less than or equal to 0.95.

In order to increase the energy density and output of the battery, the positive electrode 201 may have a thickness of greater than or equal to 10 μm and less than or equal to 500 μm.

The electrolyte layer 202 contains an electrolyte material. The electrolyte material is, for example, a solid electrolyte material. The electrolyte layer 202 may be a solid electrolyte layer.

The electrolyte layer 202 may contain the solid electrolyte material according to the first embodiment. The electrolyte layer 202 may contain greater than or equal to 50 mass % of the solid electrolyte material according to the first embodiment. The electrolyte layer 202 may contain greater than or equal to 70 mass % of the solid electrolyte material according to the first embodiment. The electrolyte layer 202 may contain greater than or equal to 90 mass % of the solid electrolyte material according to the first embodiment. The electrolyte layer 202 may consist of the solid electrolyte material according to the first embodiment only.

Hereinafter, the solid electrolyte material according to the first embodiment is referred to as first solid electrolyte material. A solid electrolyte material different from the first solid electrolyte material is referred to as second solid electrolyte material.

The electrolyte layer 202 may contain not only the first solid electrolyte material but also the second solid electrolyte material. The first solid electrolyte material and the second solid electrolyte material may be uniformly dispersed in the electrolyte layer 202. A layer made of the first solid electrolyte material and a layer made of the second solid electrolyte material may be stacked along the stacking direction of the battery 1000.

The electrolyte layer 202 may consist of the second solid electrolyte material only.

In order to increase the energy density and output of the battery, the electrolyte layer 202 may have a thickness of greater than or equal to 1 μm and less than or equal to 1000 μm.

The negative electrode 203 contains a material that can occlude and release metal ions. The negative electrode 203 contains, for example, a negative electrode active material.

Examples of the negative electrode active material are a metal material, a carbon material, an oxide, a nitride, a tin compound, and a silicon compound. The metal material may be a single metal or an alloy. Examples of the metal material are a lithium metal and a lithium alloy. Examples of the carbon material are natural graphite, coke, graphitizing carbon, carbon fibers, spherical carbon, artificial graphite, and amorphous carbon. From the viewpoint of capacity density, suitable examples of the negative electrode active material are silicon (i.e., Si), tin (i.e., Sn), a silicon compound, and a tin compound. The negative electrode active material may be a material including Li, Ti, and O. That is, the negative electrode active material may be a lithium titanium oxide. Examples of the lithium titanium oxide are Li₄Ti₅O₁₂, Li₇Ti₅O₁₂, and LiTi₂O₄.

The negative electrode active material particle 205 may have a median diameter of greater than or equal to 0.1 μm and less than or equal to 100 μm. When the negative electrode active material particle 205 has a median diameter of greater than or equal to 0.1 μm, the negative electrode active material particle 205 and the solid electrolyte particle 100 can form a good dispersion state in the negative electrode 203. Consequently, the charge and discharge characteristics of the battery are improved. When the negative electrode active material particle 205 has a median diameter of less than or equal to 100 μm, the lithium diffusion speed in the negative electrode active material particle 205 is improved. Consequently, the battery can operate at a high output.

The negative electrode active material particle 205 may have a median diameter greater than that of the solid electrolyte particle 100. Consequently, the negative electrode active material particle 205 and the solid electrolyte particle 100 can form a good dispersion state in the negative electrode 203.

In order to increase the energy density and output of the battery, in the negative electrode 203, the ratio of the volume of the negative electrode active material particle 205 to the sum of the volume of the negative electrode active material particle 205 and the volume of the solid electrolyte particle 100 may be greater than or equal to 0.30 and less than or equal to 0.95.

In order to increase the energy density and output of the battery, the negative electrode 203 may have a thickness of greater than or equal to 10 μm and less than or equal to 500 μm.

At least one selected from the group consisting of the positive electrode 201, the electrolyte layer 202, and the negative electrode 203 may contain the second solid electrolyte material in order to enhance the ion conductivity, chemical stability, and electrochemical stability. Examples of the second solid electrolyte material are a sulfide solid electrolyte, an oxide solid electrolyte, a halide solid electrolyte, and an organic polymeric solid electrolyte.

Examples of the halide solid electrolyte are Li₂MgX′₄, Li₂FeX′₄, Li(Al,Ga,In)X′₄, Li₃(Al,Ga,In)X′₆, and LiI. Here, X′ is at least one selected from the group consisting of F, Cl, Br, and I.

Other examples of the halide solid electrolyte are compounds represented by LiₐMe_{b}Y_{c}Z₆. Here, mathematical expressions: a+mb+3c=6 and c>0 are satisfied. Me is at least one selected from the group consisting of metal elements other than Li and Y and metalloid elements. Z is at least one selected from the group consisting of F, Cl, Br, and I. The value of m represents the valence of Me.

The “metalloid elements” are B, Si, Ge, As, Sb, and Te. The “metal elements” are all elements included in Groups 1 to 12 of the periodic table (however, hydrogen is excluded) and all elements included in Groups 13 to 16 in the periodic table (however, B, Si, Ge, As, Sb, Te, C, N, P, O, S, and Se are excluded).

In order to enhance the ion conductivity of the halide solid electrolyte, Me may be at least one selected from the group consisting of Mg, Ca, Sr, Ba, Zn, Sc, Al, Ga, Bi, Zr, Hf, Ti, Sn, Ta, and Nb.

Examples of the halide solid electrolyte are Li₃YCl₆ and Li₃YBr₆.

Examples of the sulfide solid electrolyte are Li₂S—P₂S₅, Li₂S—SiS₂, Li₂S—B₂S₃, Li₂S—GeS₂, Li_{3.25}Ge_{0.25}P_{0.75}S₄, and Li₁₀GeP₂Si₂.

Examples of the oxide solid electrolyte are:
(i) an NASICON-type solid electrolyte, such as LiTi₂(PO₄)₃ or its element substitute;
(ii) a perovskite-type solid electrolyte, such as (LaLi)TiO₃;
(iii) an LISICON-type solid electrolyte, such as LiI₄ZnGe₄O₁₆, Li₄SiO₄, LiGeO₄, or its element substitute;
(iv) a garnet-type solid electrolyte, such as Li₇La₃Zr₂O₁₂ or its element substitute; and
(v) Li₃PO₄ or its N-substitute.

Examples of the organic polymeric solid electrolyte are a polymeric compound and a compound of a lithium salt. The polymeric compound may have an ethylene oxide structure. A polymeric compound having an ethylene oxide structure can contain a large amount of a lithium salt and can therefore further enhance the ion conductivity.

Examples of the lithium salt are LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. One lithium salt selected from these salts may be used alone, or a mixture of two or more lithium salts selected from these salts may be used.

At least one selected from the group consisting of the positive electrode 201, the electrolyte layer 202, and the negative electrode 203 may contain a nonaqueous electrolyte solution, a gel electrolyte, or an ionic liquid for the purpose of facilitating the transfer of lithium ions and improving the output characteristics of the battery.

The nonaqueous electrolyte solution includes a nonaqueous solvent and a lithium salt dissolved in the nonaqueous solvent.

Examples of the nonaqueous solvent are a cyclic carbonate solvent, a chain carbonate solvent, a cyclic ether solvent, a chain ether solvent, a cyclic ester solvent, a chain ester solvent, and a fluorine solvent. Examples of the cyclic carbonate solvent are ethylene carbonate, propylene carbonate, and butylene carbonate. Examples of the chain carbonate solvent are dimethyl carbonate, ethyl methyl carbonate, and diethyl carbonate. Examples of the cyclic ether solvent are tetrahydrofuran, 1,4-dioxane, and 1,3-dioxolane. Examples of the chain ether solvent are 1,2-dimethoxyethane and 1,2-diethoxyethane. An example of the cyclic ester solvent is γ-butyrolactone. An example of the chain ester solvent is methyl acetate. Examples of the fluorine solvent are fluoroethylene carbonate, methyl fluoropropionate, fluorobenzene, fluoroethyl methyl carbonate, and fluorodimethylene carbonate. One nonaqueous solvent selected from these solvents may be used alone. Alternatively, a mixture of two or more nonaqueous solvents selected from these solvents may be used.

Examples of the lithium salt are LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. One lithium salt selected from these salts may be used alone. Alternatively, a mixture of two or more lithium salts selected from these salts may be used. The concentration of the lithium salt is, for example, greater than or equal to 0.5 mol/L and less than or equal to 2 mol/L.

As the gel electrolyte, a polymer material impregnated with a nonaqueous electrolyte solution can be used. Examples of the polymer material are polyethylene oxide, polyacrylonitrile, polyvinylidene fluoride, polymethyl methacrylate, and a polymer having an ethylene oxide bond.

Examples of the cation included in the ionic liquid are:
(i) an aliphatic chain quaternary salt, such as tetraalkylammonium and tetraalkylphosphonium;
(ii) aliphatic cyclic ammonium, such as pyrrolidiniums, morpholiniums, imidazoliniums, tetrahydropyrimidiniums, piperaziniums, and piperidiniums; and
(iii) a nitrogen-containing heterocyclic aromatic cation, such as pyridiniums and imidazoliums.

Examples of the anion included in the ionic liquid are PF₆⁻, BF₄⁻, SbF₆⁻, AsF₆⁻, SO₃CF₃⁻, N(SO₂CF₃)₂⁻, N(SO₂C₂F₅)₂⁻, N(SO₂CF₃)(SO₂C₄F₉)⁻, and C(SO₂CF₃)₃⁻.

The ionic liquid may contain a lithium salt.

At least one selected from the group consisting of the positive electrode 201, the electrolyte layer 202, and the negative electrode 203 may contain a binder for the purpose of improving the adhesion between individual particles.

Examples of the binder are polyvinylidene fluoride, polytetrafluoroethylene, polyethylene, polypropylene, an aramid resin, polyamide, polyimide, polyamideimide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinylpyrrolidone, polyether, polyether sulfone, hexafluoropolypropylene, styrene butadiene rubber, and carboxymethyl cellulose. A copolymer can also be used as the binder. Examples of such a binder are copolymers of two or more materials selected from the group consisting of tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene. A mixture of two or more selected from the materials above may be used as the binder.

At least one selected from the group consisting of the positive electrode 201 and the negative electrode 203 may contain a conductive assistant in order to enhance the electron conductivity.

Examples of the conductive assistant are:
(i) graphite, such as natural graphite and artificial graphite;
(ii) carbon black, such as acetylene black and Ketjen black;
(iii) conductive fibers, such as carbon fibers and metal fibers;
(iv) carbon fluoride;
(v) metal powders, such as aluminum;
(vi) conductive whiskers, such as zinc oxide and potassium titanate;
(vii) a conductive metal oxide, such as titanium oxide; and
(viii) a conductive polymeric compound, such as polyaniline, polypyrrole, and polythiophene. In order to reduce the cost, the conductive assistant of the above (i) or (ii) may be used.

Examples of the shape of the battery according to the second embodiment are coin type, cylindrical type, square type, sheet type, button type, flat type, and stacked type.

The battery according to the second embodiment may be manufactured by, for example, providing a material for forming a positive electrode, a material for forming an electrolyte layer, and a material for forming a negative electrode and producing a stack in which a positive electrode, an electrolyte layer, and a negative electrode are disposed in this order by a known method.

### EXAMPLES

The present disclosure will now be described in more detail with reference to Examples and Comparative Examples.

### Example 1

### Production of Solid Electrolyte Material

LiBr, LiI, MgBr₂, YCl₃, YBr₃, and GdCl₃ were provided as raw material powders at a molar ratio of LiBr:LiI:MgBr₂:YCl₃:YBr₃:GdCl₃=1.3:6.1:0.2:0.6:1.6:0.6 in an argon atmosphere having a dew point of less than or equal to −60° C. (hereinafter, referred to as “dry argon atmosphere”). These raw material powders were pulverized and mixed in an agate mortar. The resulting mixture was placed in an aluminum crucible and was heat-treated at 500° C. for 1 hour in a dry argon atmosphere. The obtained heat-treated product was pulverized in an agate mortar. Thus, a powder of the solid electrolyte material of Example 1 was obtained.

### Composition Analysis of Solid Electrolyte Material

The contents of Li, Mg, Y, and Gd of the obtained solid electrolyte material of Example 1 were measured by high-frequency inductively coupled plasma emission spectrometry using a high-frequency inductively coupled plasma emission spectrophotometer (manufactured by ThermoFisher Scientific, iCAP 7400). The contents of Cl, Br, and I were measured by ion chromatography using an ion chromatographic apparatus (manufactured by Dionex Corporation, ICS-2000). The composition of the solid electrolyte material was determined from the measurement results. The solid electrolyte material of Example 1 had a composition represented by Li_{2.9}Mg_{0.05}Y_{0.8}Gd_{0.2}Cl_{1.2}Br_{2.4}I_{2.4}.

### Evaluation of Ion Conductivity

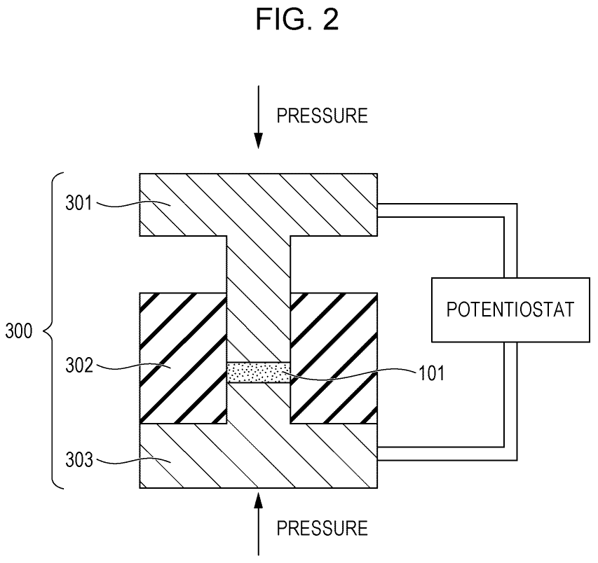

FIG. 2 shows a schematic view of a compression molding dies 300 used for evaluating the ion conductivity of a solid electrolyte material.

The compression molding dies 300 included a punch upper part 301, a die 302, and a punch lower part 303. The punch upper part 301 and the punch lower part 303 were both formed from electron-conductive stainless steel. The die 302 was formed from insulating polycarbonate.

The ion conductivity of the solid electrolyte material of Example 1 was evaluated using the compression molding dies 300 shown in FIG. 2 by the following method.

The powder 101 of the solid electrolyte material of Example 1 was loaded inside the compression molding dies 300 in a dry argon atmosphere. A pressure of 360 MPa was applied to the powder 101 of the solid electrolyte material of Example 1 inside the compression molding dies 300 using the punch upper part 301 and the punch lower part 303.

The punch upper part 301 and the punch lower part 303 were connected to a potentiostat (TOYO Corporation, VSP-300) equipped with a frequency response analyzer under application of the pressure. The punch upper part 301 was connected to the working electrode and the potential measurement terminal. The punch lower part 303 was connected to the counter electrode and the reference electrode. The impedance of a solid electrolyte material was measured by an electrochemical impedance measurement method at room temperature.

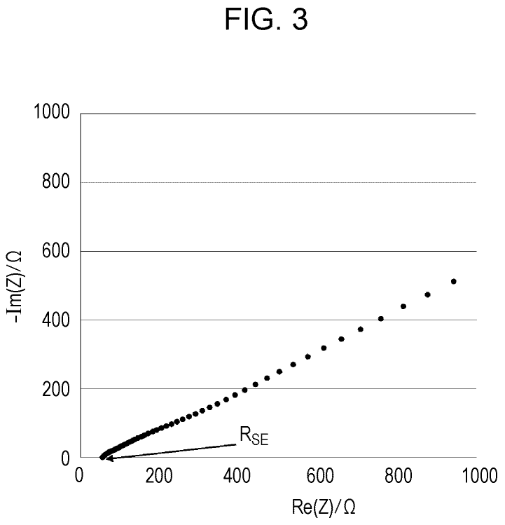

FIG. 3 is a graph showing a cole-cole plot obtained by impedance measurement of the solid electrolyte material of Example 1.

In FIG. 3, the real value of impedance at the measurement point where the absolute value of the phase of complex impedance was the smallest was regarded as the resistance value to the ionic conduction of the solid electrolyte material. Regarding the real value, see the arrow Rₛₑ shown in FIG. 3. The ion conductivity was calculated using the resistance value based on the following mathematical expression (2):

$$σ = {( {R}_{se} \times S / t )}^{- 1} . \qquad ( 2 )$$

Here, σ represents ion conductivity; S represents the contact area of a solid electrolyte material with the punch upper part 301 (equal to the cross-sectional area of the hollow part of the die 302 in FIG. 2); Rₛₑ represents the resistance value of the solid electrolyte material in impedance measurement; and t represents the thickness of the solid electrolyte material (i.e., the thickness of the layer formed from the powder 101 of the solid electrolyte material in FIG. 2).

The ion conductivity of the solid electrolyte material of Example 1 measured at 25° C. was 2.55×10⁻³ S/cm.

### X-Ray Diffraction Measurement

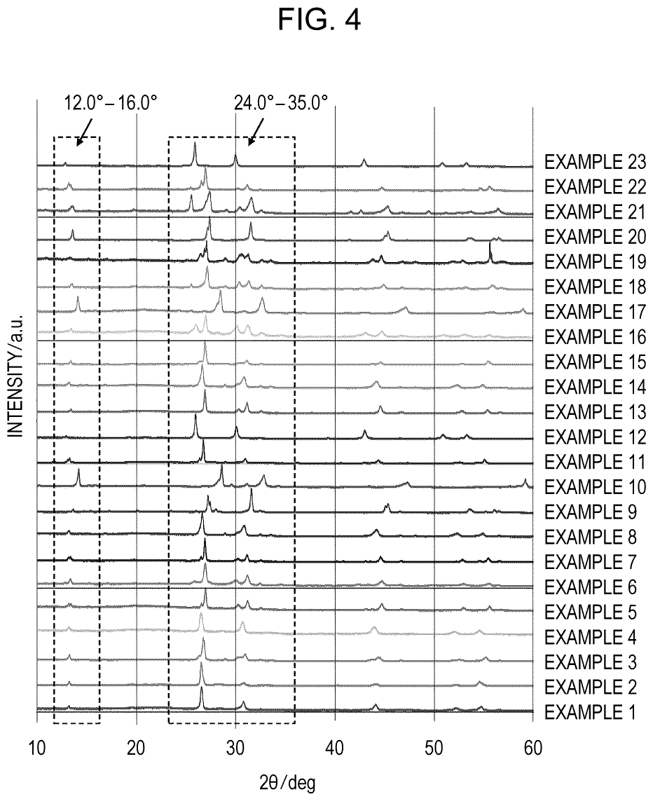

FIG. 4 is a graph showing an X-ray diffraction pattern of the solid electrolyte material of Example 1. The X-ray diffraction pattern was measured as follows.

The X-ray diffraction pattern of the solid electrolyte material of Example 1 was measured by a θ-2θ method using an X-ray diffraction apparatus (Rigaku Corporation, MiniFlex 600) in a dry atmosphere having a dew point of less than or equal to −50° C. As the X-ray source, Cu-Kα rays (wavelength: 1.5405 angstrom and 1.5444 angstrom) were used.

In the X-ray diffraction pattern of the solid electrolyte material of Example 1, at least one peak was present within a diffraction angle 2θ range of greater than or equal to 12.0° and less than or equal to 16.0°, and at least one peak was present within a diffraction angle 2θ range of greater than or equal to 24.0° and less than 29.0°. Accordingly, the solid electrolyte material of Example 1 had a monoclinic system. In the X-ray diffraction pattern, a diffraction peak having the highest intensity (i.e., the strongest peak) was present within a range of greater than or equal to 24.0° and less than 29.0°. The observed X-ray diffraction peak angles are shown in Table 2.

### Production of Battery

The solid electrolyte material of Example 1, Li₄Ti₅O₁₂, and a carbon fiber (VGCF, manufactured by Resonac Corporation) were provided at a weight ratio of 10:85:5 in a dry argon atmosphere. These materials were mixed in an agate mortar. Thus, a negative electrode mixture was obtained. “VGCF” is a registered trademark of Resonac Corporation.

The negative electrode mixture (41.7 mg) and the solid electrolyte material (160 mg) of Example 1 were stacked in this order in an insulating tube having an inner diameter of 9.5 mm. A pressure of 360 MPa was applied to this stack to form a negative electrode and a solid electrolyte layer.

Subsequently, metal In (thickness: 200 μm), metal Li (thickness: 300 μm), and metal In (thickness: 200 μm) were sequentially stacked on the solid electrolyte layer. A pressure of 80 MPa was applied to this stack to form a positive electrode.

Subsequently, a current collector formed from stainless steel was attached to the positive electrode and the negative electrode, and a current collecting lead was attached to the current collector.

Finally, the inside of the insulating tube was isolated from the outside atmosphere using an insulating ferrule to seal the inside of the tube. Thus, a battery of Example 1 was obtained.

### Charge and Discharge Test

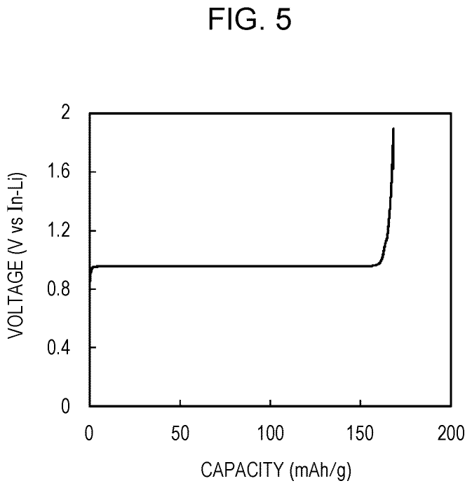

FIG. 5 is a graph showing the initial discharge characteristics of the battery of Example 1. The horizontal axis represents the discharge capacity. The vertical axis represents the voltage. The initial charge and discharge characteristics were measured by the following method.

The battery of Example 1 was placed in a thermostat of 25° C.

The battery of Example 1 was charged at a current density of 16 μA/cm² until the potential relative to Li reached 0.4 V.

Subsequently, the battery of Example 1 was discharged at a current density of 16 μA/cm² until the potential relative to Li reached 1.9 V.

As the result of the charge and discharge test, the battery of Example 1 had an initial discharge capacity of 168.4 mAh/g.

### Examples 2 to 33

### Production of Solid Electrolyte Material

In Example 2, as raw material powders, LiBr, LiI, MgBr₂, YBr₃, GdCl₃, and GdBr₃ were provided at a molar ratio of LiBr:LiI:MgBr₂:YBr₃:GdCl₃:GdBr₃=1.3:6.1:0.2:0.6:1.1:1.1.

In Example 3, as raw material powders, LiBr, LiI, MgBr₂, YCl₃, YBr₃, and GdCl₃ were provided at a molar ratio of LiBr:LiI:MgBr₂:YCl₃:YBr₃:GdCl₃=1.3:6.1:0.2:0.8:1.6:0.3.

In Example 4, as raw material powders, LiBr, LiI, MgBr₂, YBr₃, GdCl₃, and GdBr₃ were provided at a molar ratio of LiBr:LiI:MgBr₂:YBr₃:GdCl₃:GdBr₃=1.3:6.1:0.2:0.3:1.1:1.3.

In Example 5, as raw material powders, LiCl, LiBr, MgCl₂, YBr₃, YI₃, and GdBr₃ were provided at a molar ratio of LiCl:LiBr:MgCl₂:YBr₃:YI₃:GdBr₃=3.3:2.7:0.2:0.8:2.4:0.8.

In Example 6, as raw material powders, LiBr, LiI, MgBr₂, YCl₃, YBr₃, and GdCl₃ were provided at a molar ratio of LiBr:LiI:MgBr₂:YCl₃:YBr₃:GdCl₃=1.3:6.1:0.2:1.6:0.6:0.6.

In Example 7, as raw material powders, LiCl, LiBr, MgCl₂, YBr₃, YI₃, and GdBr₃ were provided at a molar ratio of LiCl:LiBr:MgCl₂:YBr₃:YI₃:GdBr₃=3.2:3.1:0.2 0.6:2.4:0.8.

In Example 8, as raw material powders, LiI, MgBr₂, YCl₃, YBr₃, and GdCl₃ were provided at a molar ratio of LiI:MgBr₂:YCl₃:YBr₃:GdCl₃=6.5:0.9:0.6:1.7:0.6.

In Example 9, as raw material powders, LiBr, LiI, MgBr₂, YBr₃, and GdBr₃ were provided at a molar ratio of LiBr:LiI:MgBr₂:YBr₃:GdBr₃=5.9:1.6:0.2:2.1:0.6.

In Example 10, as raw material powders, LiCl, LiBr, LiI, MgCl₂, YCl₃, and GdCl₃ were provided at a molar ratio of LiCl:LiBr:LiI:MgCl₂:YCl₃:GdCl₃=1.3:4.6:1.6:0.2:2.1:0.6.

In Example 11, as raw material powders, LiCl, LiBr, MgCl₂, YBr₃, YI₃, and GdBr₃ were provided at a molar ratio of LiCl:LiBr:MgCl₂:YBr₃:YI₃:GdBr₃=2.3 3.9:0.6:0.4:2.3:0.7.

In Example 12, as raw material powders, LiBr, LiI, MgBr₂, YI₃, and GdBr₃ were provided at a molar ratio of LiBr:LiI:MgBr₂:YI₃:GdBr₃=2.8:4.6:0.2:2.1:0.6.

In Example 13, as raw material powders, LiI, ZnI₂, YCl₃, YBr₃, YI₃, and GdCl₃ were provided at a molar ratio of LiI:ZnI₂:YCl₃:YBr₃:YI₃:GdCl₃=6.3:0.2:0.5 2.4:0.2:0.8.

In Example 14, as raw material powders, LiI, ZnI₂, YCl₃, YBr₃, YI₃, and GdCl₃ were provided at a molar ratio of LiI:ZnI₂:YCl₃:YBr₃:YI₃:GdCl₃=6.3:0.2:0.5 2.4:0.2:0.8.

In Example 15, as raw material powders, LiBr, LiI, ZnBr₂, YCl₃, YBr₃, and GdCl₃ were provided at a molar ratio of LiBr:LiI:ZnBr₂:YCl₃:YBr₃:GdCl₃=1:6.3:0.2:0.8:1.7:0.3.

In Example 16, as raw material powders, LiBr, LiI, ZnBr₂, YCl₃, YBr₃, and GdCl₃ were provided at a molar ratio of LiBr:LiI:ZnBr₂:YCl₃:YBr₃:GdCl₃=1:6.3:0.2:1.6:0.7:0.6.

In Example 17, as raw material powders, LiCl, LiBr, LiI, ZnCl₂, YCl₃, and GdCl₃ were provided at a molar ratio of LiCl:LiBr:LiI:ZnCl₂:YCl₃:GdCl₃=1:4.7:1.6:0.2:2.2:0.6.

In Example 18, as raw material powders, LiI, ZnBr₂, ZnI₂, YCl₃, YBr₃, and GdCl₃ were provided at a molar ratio of LiI:ZnBr₂:ZnI₂:YCl₃:YBr₃:GdCl₃=6.2:0.3:0.4:0.5:2.2:0.7.

In Example 19, as raw material powders, LiBr, LiI, ZnBr₂, YCl₃, YBr₃, and GdCl₃ were provided at a molar ratio of LiBr:LiI:ZnBr₂:YCl₃:YBr₃:GdCl₃=1.3:6.1:0.2:0.6:1.6:0.6.

In Example 20, as raw material powders, LiBr, LiI, ZnBr₂, YBr₃, and GdBr₃ were provided at a molar ratio of LiBr:LiI:ZnBr₂:YBr₃:GdBr₃=5.6:1.6:0.2:2.2:0.6.

In Example 21, as raw material powders, LiI, ZnBr₂, ZnI₂, YCl₃, YBr₃, and GdCl₃ were provided at a molar ratio of LiI:ZnBr₂:ZnI₂:YCl₃:YBr₃:GdCl₃=6.2:0.9:0.3 0.6:1.7:0.6.

In Example 22, as raw material powders, LiI, ZnI₂, YCl₃, YBr₃, and GdCl₃ were provided at a molar ratio of LiI:ZnI₂:YCl₃:YBr₃:GdCl₃=5.9:0.6:0.5:2.4:0.8.

In Example 23, as raw material powders, LiI, ZnI₂, YBr₃, YI₃, and GdBr₃ were provided at a molar ratio of LiI:ZnI₂:YBr₃:YI₃:GdBr₃=7.2:0.2:1.1:1.2:0.6.

In Example 24, as raw material powders, LiCl, LiBr, MgCl₂, YI₃, and GdBr₃ were provided at a molar ratio of LiCl:LiBr:MgCl₂:YI₃:GdBr₃=1.2:5:1.2:2.3:0.6.

In Example 25, as raw material powders, LiCl, LiBr, MgCl₂, YBr₃, YI₃, and GdBr₃ were provided at a molar ratio of LiCl:LiBr:MgCl₂:YBr₃:YI₃:GdBr₃=2.4:3.6:0.6:0.5:2.4:0.8.

In Example 26, as raw material powders, LiBr, LiI, MgBr₂, YI₃, and GdBr₃ were provided at a molar ratio of LiBr:LiI:MgBr₂:YI₃:GdBr₃=1.3:6.1:0.2:2.1:0.6.

In Example 27, as raw material powders, LiCl, LiBr, MgCl₂, YI₃, and GdBr₃ were provided at a molar ratio of LiCl:LiBr:MgCl₂:YI₃:GdBr₃=0.6:5.2:1.5:2.3:0.6.

In Example 28, as raw material powders, LiBr, LiI, ZnBr₂, YBr₃, GdCl₃, and GdBr₃ were provided at a molar ratio of LiBr:LiI:ZnBr₂:YBr₃:GdCl₃:GdBr₃=1:6.3:0.2:0.3:1.1:1.5.

In Example 29, as raw material powders, LiI, ZnBr₂, ZnI₂, YCl₃, YBr₃, and GdCl₃ were provided at a molar ratio of LiI:ZnBr₂:ZnI₂:YCl₃:YBr₃:GdCl₃=5.8:0.9:0.6 0.6:1.8:0.6.

In Example 30, as raw material powders, LiI, ZnI₂, YCl₃, YBr₃, and GdCl₃ were provided at a molar ratio of LiI:ZnI₂:YCl₃:YBr₃:GdCl₃=5.5:1:0.5:2.5:0.8.

In Example 31, as raw material powders, LiI, ZnI₂, YBr₃, YI₃, and GdBr₃ were provided at a molar ratio of LiI:ZnI₂:YBr₃:YI₃:GdBr₃=7.2:0.2:0.5:1.7:0.6.

In Example 32, as raw material powders, LiI, ZnI₂, YCl₃, YBr₃, YI₃, and GdCl₃ were provided at a molar ratio of LiI:ZnI₂:YCl₃:YBr₃:YI₃:GdCl₃=5.4:0.2:0.4:2.6:0.7:0.9.

In Example 33, as raw material powders, LiI, ZnI₂, YCl₃, YBr₃, YI₃, and GdCl₃ were provided at a molar ratio of LiI:ZnI₂:YCl₃:YBr₃:YI₃:GdCl₃=6:0.2:0.5:2.4:0.3:0.8.

Solid electrolyte materials pf Examples 2 to 33 were obtained as in Example 1 except for the above matters.

### Composition Analysis of Solid Electrolyte Material

The compositions of the solid electrolyte materials of Examples 2 to 33 were analyzed as in Example 1. The compositions of the solid electrolyte materials of Examples 2 to 33, the values of variables corresponding to those in the formula (1), and the element represented by M are shown in Table 1.

### Evaluation of Ion Conductivity

The ion conductivities of the solid electrolyte materials of Examples 2 to 33 were measured as in Example 1. The measurement results are shown in Table 1.

### X-Ray Diffraction Measurement

The X-ray diffraction patterns of the solid electrolyte materials of Examples 2 to 33 were measured as in Example 1.

FIG. 4 is a graph showing X-ray diffraction patterns of solid electrolyte materials of Examples 2 to 23. The observed X-ray diffraction peak angles are shown in Table 2. The solid electrolyte materials of Examples 2 to 23 all had a first crystal phase. In the X-ray diffraction patterns of the solid electrolyte materials of Examples 2 to 23, the strongest peaks were present within a range of greater than or equal to 24.0° and less than or equal to 35.0°. In Example 10, a halo was further observed within a range of greater than or equal to about 28.0° and less than or equal to about 33.0°. Accordingly, it is suggested that the solid electrolyte material of Example 10 included an amorphous portion.

### Charge and Discharge Test

Batteries of Examples 2 to 23 were obtained as in Example 1 using the solid electrolyte materials of Examples 2 to 23. The charge and discharge test was performed as in Example 1 using the batteries of Examples 2 to 23. As the results, the batteries of Examples 2 to 23 were well charged and discharged as in the battery of Example 1.

TABLE 1

| | | | | | | | | Ion |
|---|---|---|---|---|---|---|---|---|
| | | | | | | | | conductivity |
| | Composition | y | p | q | a | b | M | (s/cm) |
| Example 1 | Li_{2.9}Mg_{0.05}Y_{0.8}Gd_{0.2}Cl_{1.2}Br_{2.4}I_{2.4} | 0.2 | 0.4 | 0.4 | 0.05 | 0 | Mg | 2.55 × 10⁻³ |
| Example 2 | Li_{2.9}Mg_{0.05}Y_{0.2}Gd_{0.8}Cl_{1.2}Br_{2.4}I_{2.4} | 0.8 | 0.4 | 0.4 | 0.05 | 0 | Mg | 2.13 × 10⁻³ |
| Example 3 | Li_{2.9}Mg_{0.05}Y_{0.9}Gd_{0.1} Cl_{1.2}Br_{2.4}I_{2.4} | 0.1 | 0.4 | 0.4 | 0.05 | 0 | Mg | 1.75 × 10⁻³ |
| Example 4 | Li_{2.9}Mg_{0.05}Y_{0.1}Gd_{0.9}Cl_{1.2}Br_{2.4}I_{2.4} | 0.9 | 0.4 | 0.4 | 0.05 | 0 | Mg | 1.51 × 10⁻³ |
| Example 5 | Li₂Mg_{0.05}Y_{1.04}Gd_{0.26}Cl_{1.2}Br_{2.4}I_{2.4} | 0.2 | 0.4 | 0.4 | 0.05 | 0.3 | Mg | 1.44 × 10⁻³ |
| Example 6 | Li_{2.9}Mg_{0.05}Y_{0.8}Gd_{0.2}Cl_{2.4}Br_{1.2}I_{2.4} | 0.2 | 0.2 | 0.4 | 0.05 | 0 | Mg | 1.40 × 10⁻³ |
| Example 7 | Li_{2.15}Mg_{0.05}Y₁Gd_{0.25}Cl_{1.2}Br_{2.4}I_{2.4} | 0.2 | 0.4 | 0.4 | 0.05 | 0.25 | Mg | 1.37 × 10⁻³ |
| Example 8 | Li_{2.4}Mg_{0.3}Y_{0.8}Gd_{0.2}Cl_{1.2}Br_{2.4}I_{2.4} | 0.2 | 0.4 | 0.4 | 0.3 | 0 | Mg | 1.34 × 10⁻³ |
| Example 9 | Li_{2.9}Mg_{0.05}Y_{0.8}Gd_{0.2}Br_{5.4}I_{0.6} | 0.2 | 0.9 | 0.1 | 0.05 | 0 | Mg | 1.15 × 10⁻³ |
| Example 10 | Li_{2.9}Mg_{0.05}Y_{0.8}Gd_{0.2}Cl_{3.6}Br_{1.8}I_{0.6} | 0.2 | 0.3 | 0.1 | 0.05 | 0 | Mg | 1.06 × 10⁻³ |
| Example 11 | Li_{2.15}Mg_{0.2}Y_{0.92}Gd_{0.23}Cl_{1.2}Br_{2.4}I_{2.4} | 0.2 | 0.4 | 0.4 | 0.2 | 0.15 | Mg | 1.05 × 10⁻³ |
| Example 12 | Li_{2.9}Mg_{0.05}Y_{0.8}Gd_{0.2}Br_{1.8}I_{4.2} | 0.2 | 0.3 | 0.7 | 0.05 | 0 | Mg | 1.01 × 10⁻³ |
| Example 13 | Li_{2.15}Zn_{0.05}Y₁Gd_{0.25}Cl_{1.2}Br_{2.4}I_{2.4} | 0.2 | 0.4 | 0.4 | 0.05 | 0.25 | Zn | 2.26 × 10⁻³ |
| Example 14 | Li_{2.15}Zn_{0.05}Y₁Gd_{0.25}Cl_{1.2}Br_{2.4}I_{2.4} | 0.2 | 0.4 | 0.4 | 0.05 | 0.25 | Zn | 2.19 × 10⁻³ |
| Example 15 | Li_{2.75}Zn_{0.05}Y_{0.945}Gd_{0.105}Cl_{1.2}Br_{2.4}I_{2.4} | 0.1 | 0.4 | 0.4 | 0.05 | 0.05 | Zn | 1.83 × 10⁻³ |
| Example 16 | Li_{2.75}Zn_{0.05}Y_{0.84}Gd_{0.21}Cl_{2.4}Br_{1.2}I_{2.4} | 0.2 | 0.2 | 0.4 | 0.05 | 0.05 | Zn | 1.67 × 10⁻³ |
| Example 17 | Li_{2.75}Zn_{0.05}Y_{0.84}Gd_{0.21}C_{13.6}Br_{1.8}I_{0.6} | 0.2 | 0.3 | 0.1 | 0.05 | 0.05 | Zn | 1.59 × 10⁻³ |
| Example 18 | Li_{2.15}Zn_{0.2}Y_{0.92}Gd_{0.23}Cl_{1.2}Br_{2.4}I_{2.4} | 0.2 | 0.4 | 0.4 | 0.2 | 0.15 | Zn | 1.43 × 10⁻³ |
| Example 19 | Li_{2.9}Zn_{0.05}Y_{0.8}Gd_{0.2}Cl_{1.2}Br_{2.4}I_{2.4} | 0.2 | 0.4 | 0.4 | 0.05 | 0 | Zn | 1.41 × 10⁻³ |
| Example 20 | Li_{2.75}Zn_{0.05}Y_{0.84}Gd_{0.21}Br_{5.4}I_{0.6} | 0.2 | 0.9 | 0.1 | 0.05 | 0.05 | Zn | 1.39 × 10⁻³ |
| Example 21 | Li_{2.2}Zn_{0.4}Y_{0.8}Gd_{0.2}Cl_{1.2}Br_{2.4}I_{2.4} | 0.2 | 0.4 | 0.4 | 0.4 | 0 | Zn | 1.17 × 10⁻³ |
| Example 22 | Li₂Zn_{0.2}Y_{0.96}Gd_{0.24}Cl_{1.2}Br_{2.4}I_{2.4} | 0.2 | 0.4 | 0.4 | 0.2 | 0.2 | Zn | 1.05 × 10⁻³ |
| Example 23 | Li_{2.75}Zn_{0.05}Y_{0.84}Gd_{0.21}Br_{1.8}I_{4.2} | 0.2 | 0.3 | 0.7 | 0.05 | 0.05 | Zn | 1.03 × 10⁻³ |
| Example 24 | Li_{2.2}Mg_{0.4}Y_{0.8}Gd_{0.2}Cl_{1.2}Br_{2.4}I_{2.4} | 0.2 | 0.4 | 0.4 | 0.4 | 0 | Mg | 9.57 × 10⁻⁴ |
| Example 25 | Li₂Mg_{0.2}Y_{0.96}Gd_{0.24}Cl_{1.2}Br_{2.4}I_{2.4} | 0.2 | 0.4 | 0.4 | 0.2 | 0.2 | Mg | 9.35 × 10⁻⁴ |
| Example 26 | Li_{2.9}Mg_{0.05}Y_{0.8}Gd_{0.2}Br_{1.2}I_{4.8} | 0.2 | 0.2 | 0.8 | 0.05 | 0 | Mg | 7.09 × 10⁻⁴ |
| Example 27 | Li₂Mg_{0.5}Y_{0.8}Gd_{0.2}Cl_{1.2}Br_{2.4}I_{2.4} | 0.2 | 0.4 | 0.4 | 0.5 | 0 | Mg | 6.34 × 10⁻⁴ |
| Example 28 | Li_{2.75}Zn_{0.05}Y_{0.105}Gd_{0.945}Cl_{1.2}Br_{2.4}I_{2.4} | 0.9 | 0.4 | 0.4 | 0.05 | 0.05 | Zn | 8.73 × 10⁻⁴ |
| Example 29 | Li₂Zn_{0.5}Y_{0.8} Gd_{0.2}Cl_{1.2}Br_{2.4}I_{2.4} | 0.2 | 0.4 | 0.4 | 0.5 | 0 | Zn | 7.88 × 10⁻⁴ |
| Example 30 | Li_{1.8}Zn_{0.3}Y_{0.96}Gd_{0.24}Cl_{1.2}Br_{2.4}I_{2.4} | 0.2 | 0.4 | 0.4 | 0.3 | 0.2 | Zn | 7.74 × 10⁻⁴ |
| Example 31 | Li_{2.75}Zn_{0.05}Y_{0.84}Gd_{0.21}Br_{1.2}I_{4.8} | 0.2 | 0.2 | 0.8 | 0.05 | 0.05 | Zn | 7.68 × 10⁻⁴ |
| Example 32 | Li_{1.7}Zn_{0.05}Y_{1.12}Gd_{0.28}Cl_{1.2}Br_{2.4}I_{2.4} | 0.2 | 0.4 | 0.4 | 0.05 | 0.4 | Zn | 3.98 × 10⁻⁵ |
| Example 33 | Li₂Zn_{0.05}Y_{1.04}Gd_{0.26}Cl_{1.2}Br_{2.4}I_{2.4} | 0.2 | 0.4 | 0.4 | 0.05 | 0.3 | Zn | 2.03 × 10⁻⁵ |

TABLE 2

| | Diffraction peak angle (°) | | | | | |
|---|---|---|---|---|---|---|
| | Peak derived from | | | | Peak derived from | |
| | first crystal phase | | | | second crystal phase | |
| Example 1 | 13.26 | 26.65 | | | 30.88 | |
| Example 2 | 13.33 | 26.44 | | | 31.03 | |
| Example 3 | 13.17 | 26.67 | | | 30.98 | |
| Example 4 | 13.00 | 26.63 | | | 30.61 | |
| Example 5 | 13.47 | 26.99 | | | 30.35 | 31.27 |
| Example 6 | 13.40 | 27.02 | | | 30.14 | 31.31 |
| Example 7 | 13.32 | 26.95 | | | 30.18 | 31.28 |
| Example 8 | 13.26 | 26.72 | | | 30.93 | |
| Example 9 | 13.73 | 27.27 | | | 31.50 | |
| Example 10 | 14.21 | 28.65 | 32.97 | | — | |
| Example 11 | 13.10 | 26.91 | | | 30.82 | |
| Example 12 | 12.89 | 26.03 | | | 30.20 | |
| Example 13 | 13.45 | 27.00 | 32.33 | | 30.30 | 31.08 |
| Example 14 | 13.14 | 26.92 | | | 30.96 | |
| Example 15 | 13.43 | 26.83 | | | 31.06 | |
| Example 16 | 13.53 | 25.90 | 26.98 | | 30.39 | 31.37 |
| Example 17 | 14.06 | 28.72 | 32.32 | | — | |
| Example 18 | 13.43 | 25.41 | 27.22 | 32.52 | 30.47 | 31.40 |
| Example 19 | 13.62 | 26.77 | 28.92 | | 30.57 | 31.35 |
| Example 20 | 13.50 | 27.40 | | | 31.39 | |
| Example 21 | 13.43 | 25.46 | 27.36 | | 31.66 | |
| Example 22 | 13.17 | 26.87 | | | 31.06 | |
| Example 23 | 12.84 | 25.86 | | | 30.04 | |

### Consideration

The solid electrolyte materials of Examples 1 to 33 have a high lithium ion conductivity of greater than or equal to 2.03×10⁻⁵ S/cm at around room temperature.

When the value of “y” is greater than 0 and less than 1, the solid electrolyte material has a high ion conductivity. It is thought that this is because paths for diffusion of lithium ions are easily formed. In comparison of Examples 1 to 3 with Example 4, when the value of “y” is greater than 0 and less than 0.9, the solid electrolyte material has a high ion conductivity. It is thought that this is because paths for diffusion of lithium ions are easily formed. When the value of “y” is greater than or equal to 0.1 and less than or equal to 0.2, the solid electrolyte material has a high ion conductivity.

In comparison of Examples 6 and 16 with Examples 26 and 32, when the value of “p” is greater than 0, the value of “q” is greater than 0 and less than 0.8, and the value of “p+q” is less than or equal to 1, the solid electrolyte material has a high ion conductivity. It is thought that this is because paths for diffusion of lithium ions are easily formed.

When the value of “a” is greater than 0, the value of “b” is greater than or equal to 0, and the value of “a+b” is less than 0.5, the solid electrolyte material has a high ion conductivity. It is thought that this is because the amount of lithium ions in the crystal is further optimized. When the value of “b” is greater than or equal to 0 and less than or equal to 0.3, the solid electrolyte material has a high ion conductivity. When the value of “b” is greater than or equal to 0 and less than or equal to 0.25, the solid electrolyte material has a high ion conductivity. It is thought that this is because the amount of lithium ions in the crystal is further optimized.

The batteries of Examples 1 to 23 were all charged and discharged at room temperature.

Since the solid electrolyte materials of Examples 1 to 33 did not contain sulfur, hydrogen sulfide was not generated.

As described above, the solid electrolyte material of the present disclosure has a practical lithium ion conductivity. The solid electrolyte material of the present disclosure is suitable for providing a battery that can be well charged and discharged.

The solid electrolyte material of the present disclosure is used in, for example, a battery (e.g., an all-solid-state lithium ion secondary battery).

What is claimed is:

1. A solid electrolyte material comprising Li, M, Y, Gd, and I, wherein
M is at least one selected from the group consisting of Mg, Sr, Ba, and Zn.

2. The solid electrolyte material according to claim 1, further comprising X, wherein
X is at least one selected from the group consisting of Cl and Br.

3. The solid electrolyte material according to claim 1, wherein
M comprises at least one selected from the group consisting of Mg and Zn.

4. The solid electrolyte material according to claim 1, represented by a following formula (1):
Li_{3-2a-3b}M′ₐ(Y_{1-y}Gd_{y})_{1+b}(Cl_{1-p-q}BrₚI_{q})₆ (1)
here, M′ is at least one selected from the group consisting of Mg and Zn, and
following mathematical expressions:
0<y<1;
0≤p<1;
0<q≤1;
0<(p+q)≤1;
0<a;
0≤b; and
0<(a+b)<1
are satisfied.

5. The solid electrolyte material according to claim 4, wherein
in the formula (1), a mathematical expression: 0<(a+b)<0.5 is satisfied.

6. The solid electrolyte material according to claim 4, wherein
in the formula (1), a mathematical expression: 0.1≤y≤0.9 is satisfied.

7. The solid electrolyte material according to claim 6, wherein
in the formula (1), a mathematical expression: 0.1≤y≤0.2 is satisfied.

8. The solid electrolyte material according to claim 4, wherein
in the formula (1), a mathematical expression: 0.2≤p≤0.9 is satisfied.

9. The solid electrolyte material according to claim 4, wherein
in the formula (1), a mathematical expression: 0<q<0.8 is satisfied.

10. The solid electrolyte material according to claim 9, wherein
in the formula (1), a mathematical expression: 0.1≤q≤0.7 is satisfied.

11. The solid electrolyte material according to claim 4, wherein
in the formula (1), a mathematical expression: 0.05≤a≤0.4 is satisfied.

12. The solid electrolyte material according to claim 4, wherein
in the formula (1), a mathematical expression: 0≤b≤0.25 is satisfied.

13. The solid electrolyte material according to claim 1, wherein
in an X-ray diffraction pattern obtained by X-ray diffraction measurement using Cu-Kα rays,
at least one peak is present within a diffraction angle 2θ range of greater than or equal to 12.0° and less than or equal to 16.0°, and
at least one peak is present within a diffraction angle 2θ range of greater than or equal to 24.0° and less than 29.0°.

14. The solid electrolyte material according to claim 1, wherein
in an X-ray diffraction pattern obtained by X-ray diffraction measurement using Cu-Kα rays,
a full width at half maximum of a peak having a highest intensity within a range of greater than or equal to 25.0° and less than or equal to 30.0° is less than or equal to 0.30°.

15. The solid electrolyte material according to claim 1, wherein
in an X-ray diffraction pattern obtained by X-ray diffraction measurement using Cu-Kα rays,
at least one peak is present within a diffraction angle 2θ range of greater than or equal to 29.0° and less than or equal to 32.0°.

16. The solid electrolyte material according to claim 1, comprising:
a crystal phase belonging to a trigonal system.

17. The solid electrolyte material according to claim 1, comprising:
a crystal phase belonging to a monoclinic system.

18. A battery comprising:
a positive electrode;
a negative electrode; and
an electrolyte layer provided between the positive electrode and the negative electrode, wherein
at least one selected from the group consisting of the positive electrode, the negative electrode, and the electrolyte layer comprises the solid electrolyte material according to claim 1.
